(19) United States
(12) Patent Application Publication
(10) Pub. No.: US 2005/0195339 A1
(43) Pub. Date: Sep. 8, 2005

(54) Light source device emitting light in rectangular shape

(75) Inventors: Goroh Saitoh, Tokyo (JP); Fujio Okumura, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/050,893

(22) Filed: Feb. 7, 2005

(30) Foreign Application Priority Data
Feb. 5, 2004 (JP) 2004-028887

(51) Int. Cl. G02F 1/1335

(52) U.S. Cl. 349/61; 349/5

(57) ABSTRACT

A light source device comprises a light source element including a light emitting element for emitting light mainly from a yz-plane in a three-dimensional orthogonal coordinate system defined by an x-axis, a y-axis, and a z-axis, and an element reflection plane for reflecting the light emitted from the light emitting element in the x-axis direction to head in a di rection parallel with the yz-plane, and a device reflection plane for reflecting the light emitted from the light source element in a direction parallel with the yz-plane to head in the y-axis direction.

### BACKGROUND OF THE INVENTION

1. Field of the Invention

The present invention relates to a light source device having a light emitting element, etc., and more particularly, to a light source device suitable for a projector apparatus.

2. Description of the Related Art

In recent years, the demand has been growing for projector apparatuses using liquid crystal elements or DMD (digital micromirror device) elements in use for displaying documents in conference rooms or for displaying images for home theaters, and research and development have been widely conducted for such projector apparatuses.

FIGS. 1A, 1B illustrate an exemplary conventional light source device for use in a projector apparatus, disclosed in specification etc. of Japanese Patent Laid-open Publication No. 2003-45204. FIG. 1A is a cross-sectional view of a light source device cut along a yz-plane, seen from an x-axis direction, and FIG. 1B is a side view of the light source device seen from a y-axis direction. The following description will be made with reference to FIGS. 1A, 1B. For reference, in the appended drawings, light paths are represented by broken line arrows.

Conventional light source device 90 comprises, as main components, light emitting element 91 which emits light mainly from a zx-plane of an orthogonal coordinate system defined by an x-axis, a y-axis, and a z-axis; and a parabolic reflection plane 92 for reflecting the light emitted from light emitting element 91 about a −y-direction in a y-axis direction. Illuminated object 93 such as a lens system, a display element etc. is disposed in the +y-axis direction. Emitted light from light emitting element 91 extensively spreads about the −y-axis direction, then is reflected by parabolic reflection plane 92 for transformation into collimated light having a substantially circular emission plane, which is irradiated to Illuminated object 93.

However, conventional light source device 90, since emitted light has a circular emission plane, whereas Illuminated object 93 is rectangular, fails to utilize part of the emitted light. This causes a problem of a lower light utilization efficiency. In addition, since conventional light source device 90 experiences difficulties in narrowing down the angle of emitted light, it is difficult to reduce the size of light source device 90.

### SUMMARY OF THE INVENTION

It is an object of the present invention to provide a light source device etc. which achieves high light utilization efficiency (low power consumption) and a narrow light emission angle, which is simple and inexpensive, and is capable of being reduced in size.

A light source device according to the present invention includes a light source element and a device reflection plane. The light source element includes a light emitting element for emitting light mainly from a yz-plane in a three-dimensional orthogonal coordinate system defined by an x-axis, a y-axis, and a z-axis, and an element reflection plane for reflecting the light emitted from the light emitting element in the x-axis direction to head in a direction parallel with the yz-plane. The device reflection plane reflects the light emitted from the light source element in a direction parallel with the yz-plane to head in the y-axis direction.

The light emitting element emits light mainly in the x-axis direction and additionally emits light in the ±y-axis directions and ±z-axis directions based on its light distribution characteristics. The emitted light from the light emitting element in the x-axis direction is reflected by the element reflection plane to head in the direction parallel with the yz-plane. A majority of the reflected light is again reflected by the device reflection plane in the +y-axis direction, while the rest of the reflected light is directly headed in the +y-axis direction. Since the emitted light from the light emitting element is utilized in such an effective way, the light source device provides high light utilization efficiency. Furthermore, since a majority of emitted light from the light source element travels in parallel with the yz-plane, a narrow emission light angle can be achieved in the z-axis direction. This permits the width of the device reflection plane to be narrower in the z-axis direction, thus accomplishing a reduction in size of the light source device.

According to another embodiment, the device reflection plane may have a concave shape in the yz-plane and in planes parallel with the yz-plane. said device reflection plane has a concave shape in an xy-plane of the three-dimensional orthogonal coordinate system and in planes parallel with the xy-plane. The device reflection plane also may have a pair of end surfaces in the z-axis direction formed to be plane parallel with the xy-plane; and the device reflection plane may have a pair of end surfaces in the x-axis direction formed to be plane parallel with the yz-plane. A larger amount of emitted light from the light source element in the direction parallel with the yz-plane is reflected in the y-axis direction. The concave shape may be a parabolic shape. The parabolic shape means a parabola or a shape similar to a parabola.

According to another aspect of the present invention, an projector apparatus comprises the light source devices according to the invention each for emitting red, green, and blue light, display means for displaying an image for each of a red component, a green component, and a blue component, and projection means for projecting the image on a screen by irradiating said display means with light in the same color as the image of the color component which is displayed on said display means, wherein the light is emitted from the associated light source device.

According to yet another aspect of the present invention, an illuminator includes the light source device according to the present invention for emitting red, green, and blue light, or white light.

According to still yet another aspect of the present invention, a liquid crystal display comprises a transmission type liquid crystal display panel and a back light disposed on a back of said liquid crystal display panel, said back light including the illuminator according to the present invention.

According to the light source device of the present invention, the light emitted from the light emitting element in the x-axis direction is reflected to head in a direction parallel with the yz-plane by the element reflection plane, then the reflected light is further reflected in the y-axis direction by the device reflection plane. Since emitted light from the light emitting element can be effectively utilized in such a manner, high light utilization efficiency can be achieved. A majority of emitted light from the light source element travels parallel with the yz-plane, a narrow emission light angle can be accomplished in the z-axis direction. Consequently, the width of device reflection plane can be narrowed down in the z-axis direction, and the light source device can also be reduced in size.

In other words, the present invention can provide a light source device which exhibits high light utilization efficiency (low power consumption) and a narrow emission light angle, which is simple and inexpensive, and can be reduced in size, as well as a projector apparatus, an illuminator, and a liquid crystal display which include the light source device and accomplish low power consumption, low cost, and bright images.

The above and other objects, features and advantages of the present invention will become apparent from the following description with reference to the accompanying drawings which illustrate examples of the present invention.

### BRIEF DESCRIPTION OF THE DRAWINGS

FIG. 1A is a cross-sectional view cut along a yz-plane and seen from an x-axis direction, illustrating an example of conventional light source device;

FIG. 1B is a side view cut along a yz-plane and seen from a y-axis direction, illustrating the conventional light source device of FIG. 1A;

FIG. 2A is a front view, seen from the x-axis direction, illustrating a first embodiment of a light source device according to the present invention;

FIG. 2B is a cross-sectional view taken along I-I line in FIG. 2A (partially enlarged cross-sectional view cut along an xy-plane);

FIG. 3A is a perspective view generally illustrating a first embodiment of the light source device according to the present invention;

FIG. 3B is a side view, seen from the y-axis direction, of the light source device illustrated in FIG. 3A;

FIG. 4A is a partially enlarged cross-sectional view, cut along the xy-plane, illustrating a second embodiment of the light source device according to the present invention;

FIG. 4B is a partially enlarged cross-sectional view, cut along the xy-plane, illustrating a third embodiment of the light source device according to the present invention;

FIG. 5A is a partially cut-away perspective view generally illustrating a fourth embodiment of the light source device according to the present invention;

FIG. 5B is a cross-sectional view taken along IV-IV line in FIG. 5A (cross-sectional view cut along the xy-plane);

FIG. 6A is a front view, seen from the x-axis direction, illustrating the fourth embodiment of the light source device according to the present invention;

FIG. 6B is a partial cross-sectional view, cut along the xy-plane, of the light source device illustrated in FIG. 6A;

FIG. 7 is a perspective view illustrating a fifth embodiment of the light source device according to the present invention;

FIG. 8A is a schematic diagram illustrating the configuration of a first embodiment of a projector apparatus according to the present invention;

FIG. 8B is a schematic diagram illustrating the configuration of a second embodiment of a projector apparatus according to the present invention;

FIGS. 9A to 9C are schematic diagrams illustrating the configuration of a third embodiment of a projector apparatus according to the present invention;

FIGS. 10A to 10C are schematic diagrams illustrating the configuration of a fourth embodiment of a projector apparatus according to the present invention;

FIG. 11A is a perspective view illustrating a first embodiment of an illuminator according to the present invention;

FIG. 11B is a cross-sectional view taken along X-X line of the illuminator illustrated in FIG. 11A;

FIG. 12A is a perspective view illustrating a first embodiment of a liquid crystal display according to the present invention; and

FIG. 12B is a perspective view illustrating a second embodiment of a liquid crystal display according to the present invention.

### DETAILED DESCRIPTION OF THE PREFERRED EMBODIMENTS

First, description will be made on the general outlines of a light source device etc. according to the present invention.

In the following description, assume that a light emitting element mainly emits light in the yz-plane, and the x-axis is perpendicular to the main emission plane. The light source device of the present invention is featured in that it comprises a light source element having an element reflection plane for reflecting light emitted from a light emitting element in the x-axis direction to head in a direction parallel with a yz-plane; a device reflection plane for reflecting light emitted from the light source element in the direction parallel with the yz-plane to head in a predetermined direction within the yz-plane (this predetermined direction is a y-direction); and a lens disposed in the y-axis direction. The main emission plane of the light emitting element means a plane through which the largest amount of light is emitted. A lens is disposed in the y-axis direction in order to further narrow down an emission angle distribution of the light emitted from the light source device.

The device reflection plane has a cross-section in a parabolic shape or a shape similar to a parabola in the yz-plane. The cross section of the device reflection plane in the planes parallel with the yz-plane may be the same as the cross section in the yz-plane. This arrangement makes it possible that the emission angle distribution on the yz-plane for the emitted light from the light source device is narrowed down, and the emitted light from the light source device is transformed into a rectangular shape. The both of cross sections of the device reflection plane in the yz-plane and in the xy-plane may be in parabolic shapes or shapes similar to a parabola, and the device reflection plane may be provided with end faces parallel with the yz-plane and end faces parallel with xy-plane. This arrangement makes it possible that the emission angle distribution of the emitted light from the light source device on the yz-plane and xy-plane is narrowed down, and the light from the light source device is emitted in a shape closer to a rectangular shape.

The lens disposed in the y-direction is preferably a cylindrical lens.

The emitted light from the light source element may be any one or any combination of red, green and blue light. Alternatively, the emitted light from the light source element may be white light. The light source element is preferably a light emitting diode (LED) because of its ease of handling, lower power consumption, low price etc.

The foregoing light source device may be used as a single light source unit, and a plurality of the light source units may be arranged side by side to be combined into another light source device. The plurality of light source units arranged side by side may share a lens to reduce the number of parts and the number of assembling steps. The plurality of light source units arranged side by side may emit light in the same color or emit light in different colors from one another.

With the use of the foregoing light source device, a projector apparatus can be provided which features lower power consumption, low cost, and bright images. A color image can be displayed by lighting the light source device sequentially in the three primary colors, i.e., red, green, blue, and displaying images of a red component, a green component, and a blue component on the display element in time series synchronized with the lighting of the light source device. A color image can also be displayed by dividing the display element in the projector apparatus into a plurality of areas and displaying images of a red component, a green component, and a blue component in the respective areas in time series, while irradiating the respective areas with red, green, and blue light, respectively, synchronized with displayed colors in the respective areas of the display element.

A low power consumption, inexpensive and bright illuminator can be provided by introducing emitted light from the light source device into a light guide plate, and generating planar light emitted from the light guide plate. Emitted light from the light source may be in three colors, i.e., red, green, blue, or in white.

A low power consumption, inexpensive, and bright liquid crystal display can be provided by disposing a liquid crystal display element on the emission plane of the illuminator. A color image can be displayed by lighting the illuminator in the three primary colors, i.e., red, green, and blue in sequence, while displaying images of a red component, a green component, and a blue component on the liquid crystal display element in time series synchronized with the lighting of the illuminator. A color image can also be displayed by dividing the liquid crystal display element into a plurality of areas and displaying images of a red component, a green component, and a blue component in the respective areas in time series, while irradiating the respective areas with red, green, and blue light, respectively, synchronized with displayed colors in the respective areas of the liquid crystal display element.

The light source device of the present invention can be used as a light source for a projector apparatus in combination with an integrator illumination system, a projection lens, etc. Since the light source device of the present invention has high light utilization efficiency (low power consumption) and a narrow light emission angle, is simple and inexpensive, a projector apparatus can be provided which is inexpensive and presents bright images with lower power consumption.

A low power consumption, inexpensive, and bright illuminator can be implemented by introducing emitted light from the light source device of the present invention into a light guide plate, and forming a prism or printing a reflection pattern on a plane opposite to an emission plane to generate planar light emitted from the light guide plate. A low power consumption, inexpensive, and bright liquid crystal display can be provided by disposing a liquid crystal display element on the emission plane of the illuminator.

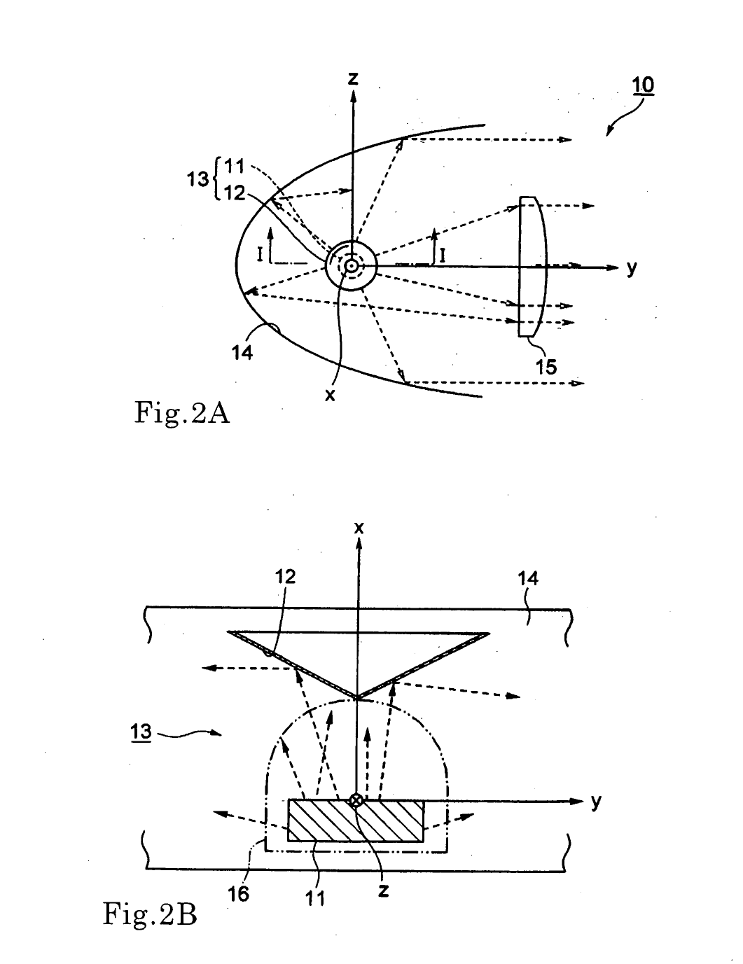

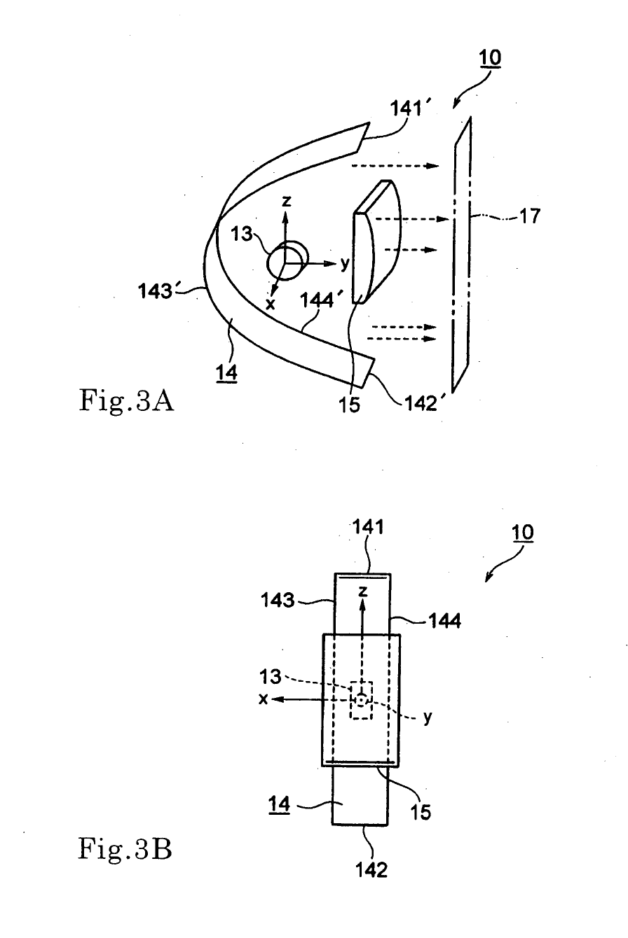

Next, description will be made on some embodiments of the light source device and associated apparatuses which incorporate the light source device according to the present invention. FIGS. 2A to 3B illustrate a first embodiment of the light source device according to the present invention. FIG. 2A is a front view seen from the x-axis direction; FIG. 2B is a cross-sectional view taken along I-I line in FIG. 2A (partially enlarged cross-sectional view cut along the xy-plane); FIG. 3A is a perspective view of the whole light source device; and FIG. 3B is a side view seen from the y-axis direction. The following description will be made with reference to these figures. Assume in FIG. 2A that the origin is defined at the center of a light emission plane of a light emitting element, the x-axis extends from the origin (back) to the front, the y-axis extends from the origin (left) to the right, and the z-axis extends upward from the origin (below). This definition of the coordinate system is the same as a three-dimensional orthogonal coordinate system which is commonly used in physics and mathematics.

Light source device 10 according to the embodiment comprises light source element 13 and device reflection plane 14. Light source element 13 comprises light emitting element 11 which emits light mainly from the yz-plane of the three-dimensional orthogonal coordinate system defined by the x-axis, y-axis, and z-axis; and element reflection plane 12 which reflects light emitted from light emitting element 11 in the x-axis direction in directions parallel with the yz-plane. Device reflection plane 14 reflects light emitted from light source element 13 in directions parallel with the yz-plane to head in the +y-axis direction.

Light emitting element 11 may be LED which is encapsulated in jacket 16 made of resin. A plurality of light emitting elements 11 different in light emission wavelength from one another may be provided in light source element 13 to emit light in a plurality of colors with single light source element 13. For example, a plurality of LED chips different in light emission wavelength may be encapsulated in single jacket 16. EL (Electroluminescent) lamp or the like may be used instead of LED.

Element reflection plane 12 is conical in shape, and is fixed to jacket 16 (FIG. 2B) by adhesion. Lens 15, which is a convex cylindrical lens, may be omitted in some cases. Device reflection plane 14 has a parabolic shape in the yz-plane and planes parallel with the yz-plane. Device reflection plane 14 is defined by edges 141′, 142′ parallel with the xy-plane, and edges 143′, 144′ parallel with the yz-plane. Element reflection plane 12 and device reflection plane 14 may be formed, for example, by vapor depositing aluminum on plastic. Glass or the like may be used instead of plastic. Silver or the like may be used instead of aluminum. Plating or the like may be used instead of vapor deposition.

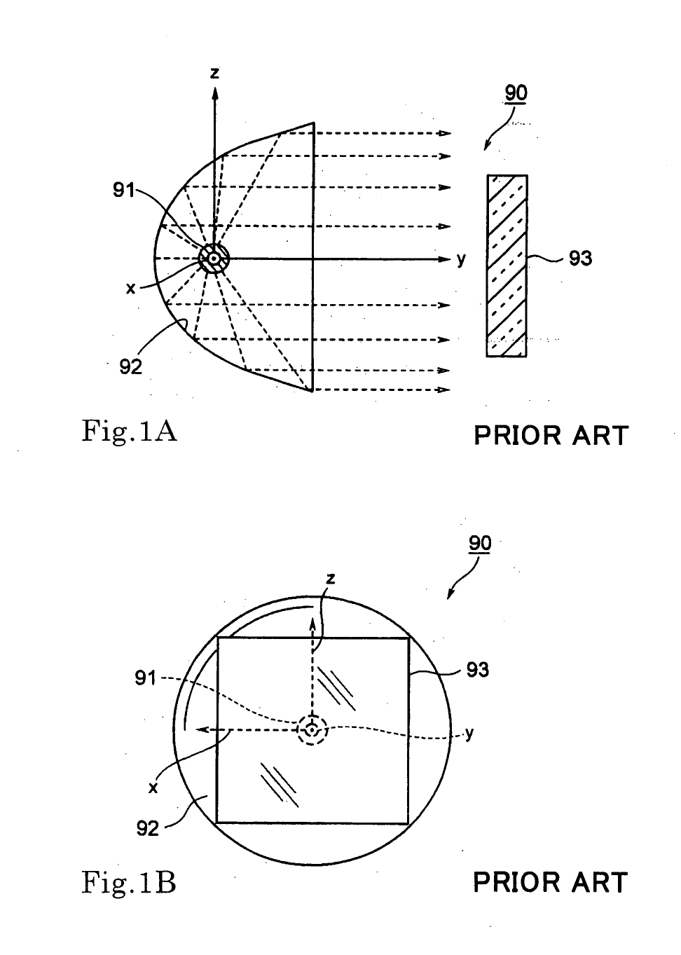

Next, description will be made on the operation of light source device 10. Light emitting element 11 emits light mainly in the x-axis direction, and additionally emits light in ±y-axis directions and in ±z-axis directions based on its light distribution characteristic. Emitted light from light emitting element 11 in the x-axis direction is reflected by element reflection plane 12 to head in the directions parallel with the yz-plane. A majority of the reflected light is again reflected by device reflection plane 14 in the y-axis direction, while the rest of the reflected light is directly headed in the +y-axis direction. Emitted light from light emitting element 11 in the ±y-axis directions and ±z-axis directions, which light is emitted light parallel with the yz-plane, is predominantly reflected by device reflection plane 14 in the y-axis direction, and the rest is headed directly in the y-axis direction. The emitted light from light emitting element 11 is utilized in such an effective way, and the light source device 10 provides high light utilization efficiency. Furthermore, since a majority of emitted light from the light source element 13 travels in parallel with the yz-plane, a narrow emission light angle can be achieved in the z-axis direction. This permits the width of the device reflection plane 14 to be narrower in the z-axis direction, thus accomplishing a reduction in size of the light source device 10. It should be noted that in conventional light source device 90 illustrated in FIGS. 1A, 1B, parabolic reflection plane 92 cannot be reduced in width in the z-axis direction, because emitted light from light emitting element 91 extensively travels about the −y-axis direction. In addition, device reflection plane 14 is simple in structure, as compared with conventional parabolic reflection plane 92 illustrated in FIGS. 1A, 1B, and is manufactured with ease.

The operation of light source device 10 will be again described from another point of view. First described is light source element 13. Assume that a main emission plane of light emitting element 11, i.e., the plane from which the largest amount of light is emitted, is the yz-plane, and a direction perpendicular to this main emission plane is a x-axis. Light source element 13 has element reflection plane 12 disposed in the x-axis direction of light emitting element 11. Light emitted from light emitting element 11 in the x-axis direction is reflected by element reflection plane 12, and headed in the directions parallel with the yz-plane. In other words, light source element 13 emits substantially whole light from light emitting element 11 in the directions parallel with the yz-plane.

Device reflection plane 14 surrounds light source element 13, and reflects light from light source element 13 in a predetermined direction (+y-axis direction). Lens 15 disposed in the y-axis direction converges light reflected by device reflection plane 14 and light from light source element 13 to narrow down an emission angle distribution of the emitted light from light source device 10.

Device reflection plane 14 is designed to have a cross section in the yz-plane in a parabolic shape or a shape similar to a parabola to narrow down the emission angle distribution of emitted light from light source device 10 on the yz-plane, and to have cross sections on planes parallel with the yz-plane identical to that on the yz-plane to emit light from light source device 10 in a rectangular shape on emission plane 17, as illustrated in FIG. 3A. Light source element 13 directs substantially whole light emitted from light emitting element 11 in the direction parallel with the yz-plane. Thus, light from light emitting element 11 is emitted by light source device 10 at high efficiency and in a narrow emission angle distribution, so that no reflection plane need be arranged in the x-axis direction of light source device 10. In conventional light source device 90 illustrated in FIGS. 1A, 1B, light source device 90 must be covered with parabolic reflection plane 92 except for its emission plane in order to efficiently collect emitted light from light emitting element 91. Furthermore, as illustrated in FIG. 3A, light source device 10 provides emission plane 17 in a rectangular shape, so that light source device 10 can eliminate uselessly emitted light due to the difference in shape between the emission plane and an Illuminated object when it is used in a projector apparatus etc.

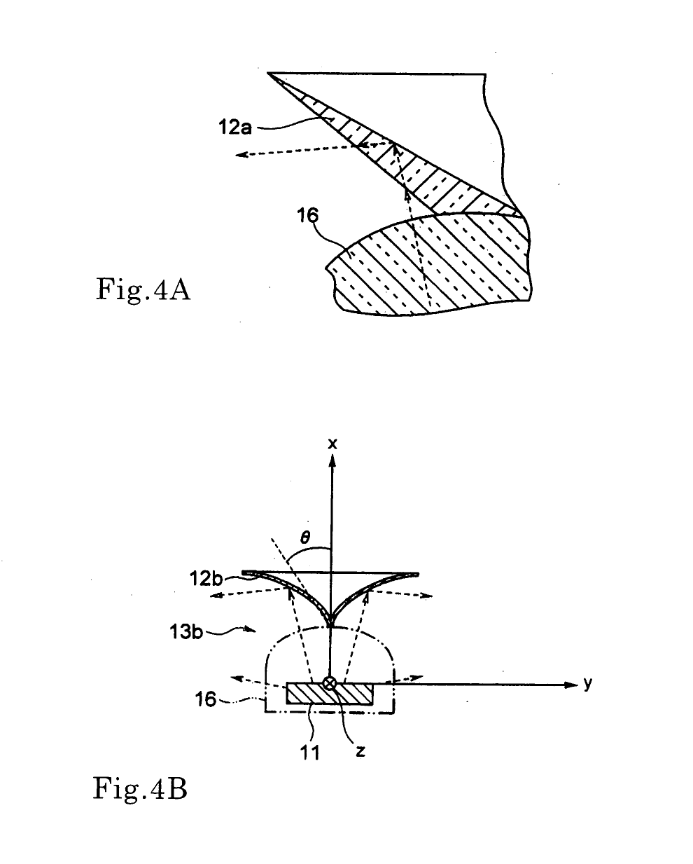

FIG. 4A is a partially enlarged cross-sectional view, cut along the xy-plane, illustrating a second embodiment of the light source device according to the present invention. The following description will be made with reference to FIG. 4A. Illustration and description common to the first embodiment will be omitted.

The second embodiment is featured in that element reflection plane 12a is made only of plastic. As illustrated, light from a light emitting element (not shown) is reflected due to the difference in refractive index between the plastic and air on the interface therebetween. Since element reflection plane 12a can be molded integrally with jacket 16 of the light emitting element, the light source device of the second embodiment can be advantageously manufactured at a lower cost because of a reduction in the number of parts and the number of assembling steps. The light utilization efficiency can be further increased by forming a groove structure and/or a prism structure on element reflection plane 12a. Instead of plastic, glass or the like may be used.

FIG. 4B is a partially enlarged cross-sectional view cut along the xy-plane, illustrating a third embodiment of the light source device according to the present invention. The following description will be made with reference to FIG. 4B. Illustration and description common to the first embodiment will be omitted.

The third embodiment is featured by the structure of element reflection plane 12b. Element reflection plane 12b has a larger angle θ formed by its tangential line and the x-axis at positions further away from light emitting element 11. Specifically, assuming the x-axis is on the center of the main emission plane of light emitting element 11, the tangential line of element reflection plane 12b has an angle θ in a range of 30 to 55° to the x-axis near the x-axis, the angle θ increasing as the position is further away from the x-axis, and has an angle θ in a range of 45 to 70° at its end portion. This structure enables element reflection plane 12b to further narrow down the light emission angle distribution from light source element 13b.

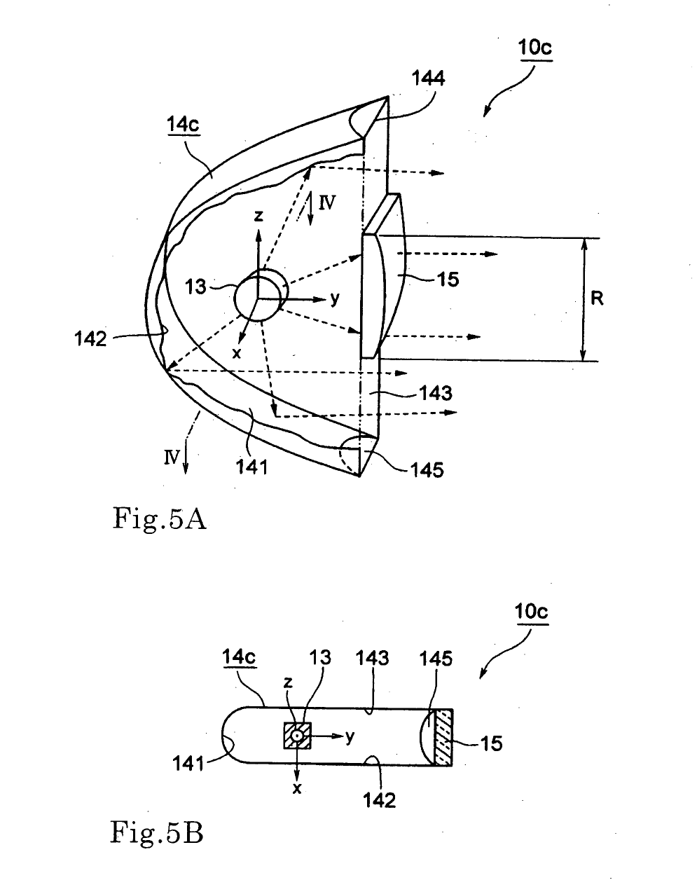

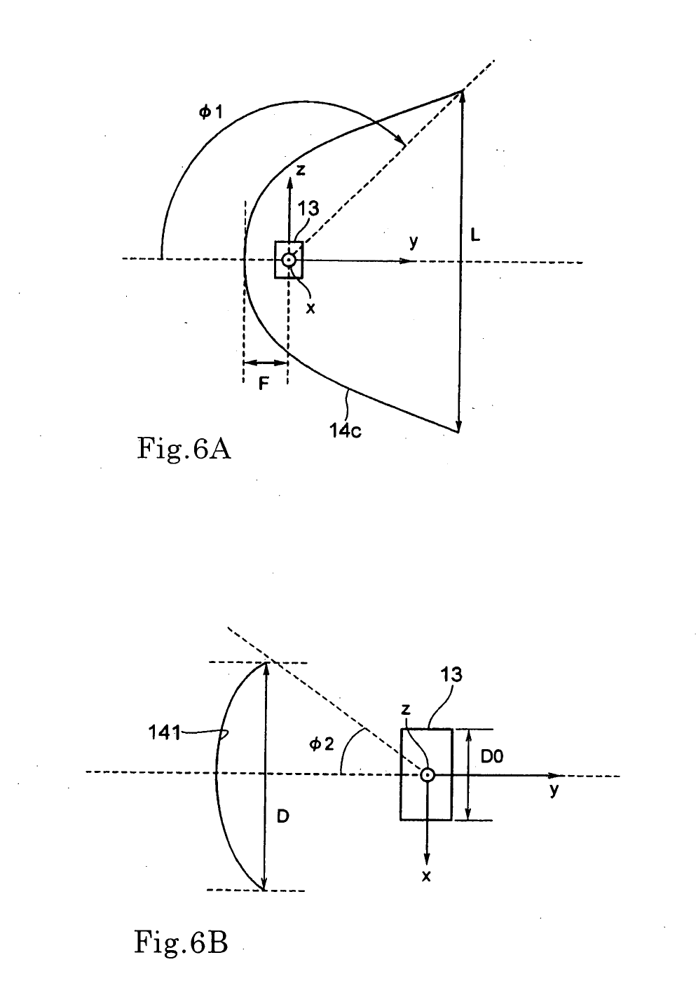

FIGS. 5A to 6B illustrate a fourth embodiment of the light source device according to the present invention. FIG. 5A is a partially cut-away perspective view of the whole light source device; FIG. 5B is a cross-sectional view taken along line IV-IV in FIG. 5A (i.e., a cross-sectional view cut along the xy-plane); FIG. 6A is a front view seen from the x-axis direction; and FIG. 6B is a partial cross-sectional view cut along the xy-plane. The following description will be made with reference to these figures. Parts identical to those in FIGS. 2A, 2B are designated the same reference numerals, and will be omitted in the description.

Light source device 10c of the third embodiment is featured by the structure of device reflection plane 14c. First, light source device 10c is featured by main surface 141 which has a cross section in a parabolic shape or in a shape similar to a parabola in the xy plane as well as the cross-section in the yz-plane. Second, light source device 10c is featured by end faces 142, 143 parallel with the xy-plane, and end faces 144, 145 parallel with the yz-plane. The first feature contributes to narrowing down the emission angle distribution of emitted light from light source device 10c on the xy-plane, and forming the emitted light from light source device 10c into a shape closer to a rectangular shape, together with the operation of the second feature. Either of the two features alone may be employed in light source device 10c. End faces 142, 143 may be bands of arc extending along the peripheral edges of main surface 141, although they are illustrated as large semicircles.

Description will be made on desired dimensions of device reflection plane 14c. Assume in FIG. 6A that the focal distance of a parabola is designated by F, the length of an aperture by L, and light from light source element 13 is taken at an angle φ1. Aperture length L is preferably 3 to 10 times larger than focal distance F, and φ1 is preferably in a range of 90 to 140°, in order that light source device 10c further improves light utilization efficiency. Light source element 13 is positioned at the focus of the parabola. Further, as illustrated in FIG. 6B, depth D of main surface 141, which has a cross-section in a parabolic shape in the xy-plane, is wider than width D0 of light source element 13, and assume that light from light source element 13 is taken at an angle φ2. Device reflection plane 14c is preferably designed to satisfy φ2<30° in order that light source device 10c further improves light utilization efficiency and further reduce a space required therefor. As illustrated in FIG. 5A, cylindrical lens 15 preferably has width R in the range between D0 and L from a viewpoint of the light utilization efficiency and narrower emission light angle of light source device 10c.

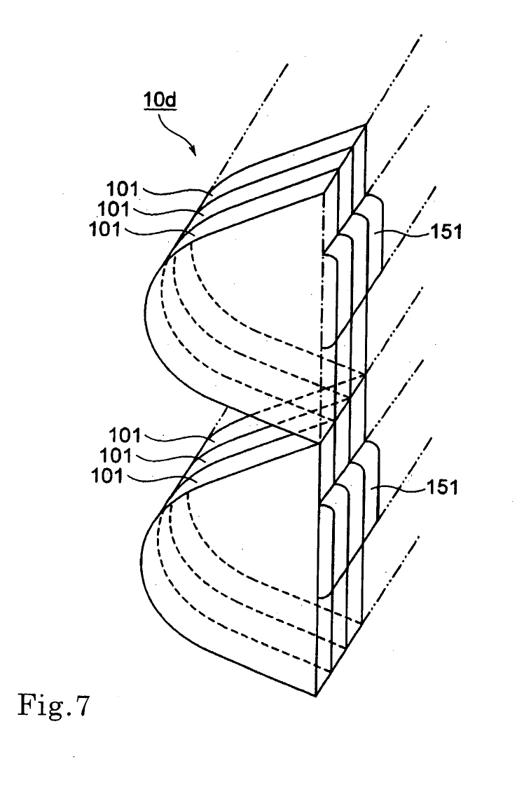

FIG. 7 is a perspective view illustrating a fifth embodiment of the light source device according to the present invention. The following description will be made with reference to FIG. 7.

In the fifth embodiment, one of the light source devices according to the foregoing first to fourth embodiments is employed as light source unit 101, and a plurality of light source units 101 are arranged side by side to be combined into another light source device 10d. The plurality of light source units 101 share single elongated lens 151 to reduce the number of parts and the number of assembling steps.

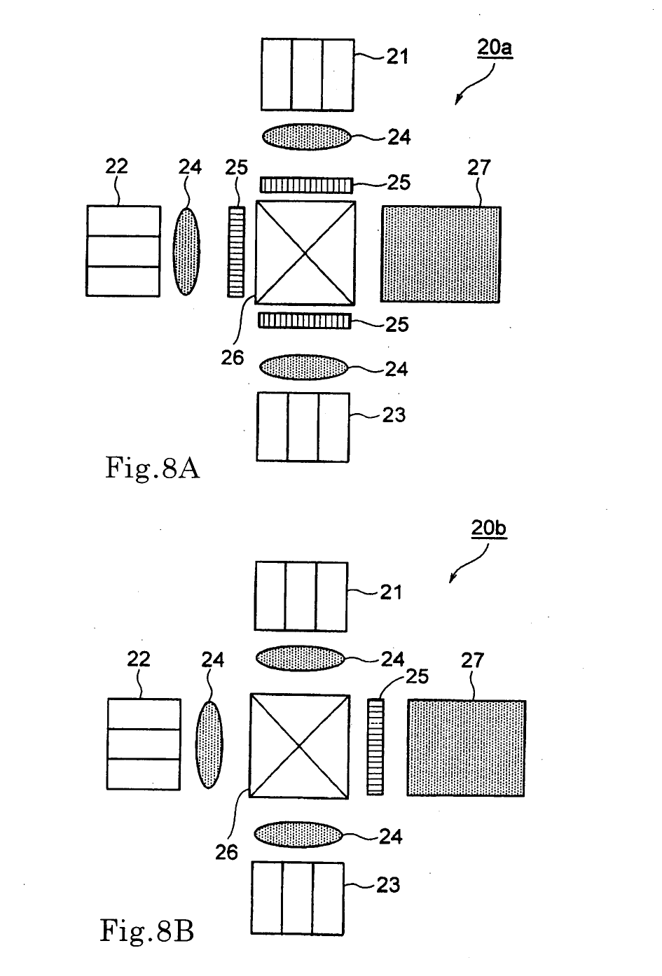

FIG. 8A is a schematic diagram illustrating the configuration of a first embodiment of a projector apparatus according to the present invention. The following description will be made with reference to FIG. 8A.

Projector apparatus 20a of this embodiment employs light source device 10d (FIG. 7) according to the present invention. Specifically, a plurality of light source units 101 (FIG. 7) each including red LED are arranged in matrix (for example, in three columns vertically and in three rows horizontally) to create red light source device 21. Similarly, green light source device 22 and blue light source device 23 are created. These light source devices are combined with illumination optical systems 24, liquid crystal display elements 25, dichroic prism 26, and projection optical system 27 to create a three-plate liquid crystal projector. Liquid crystal display elements 25 corresponds to “display means” in claims, while illumination optical systems 24, dichroic prism 26, and projection optical system 27 correspond to “projection means” in claims. Employing light source devices 10d (FIG. 7) which provides high light utilization efficiency for emitted light and a narrow light emission angle distribution enables projector apparatus 20a to achieve low power consumption and improved luminance. Alternatively, a DMD element or the like may be used instead of liquid crystal display element 25.

FIG. 8B is a schematic diagram illustrating a second embodiment of the projector apparatus according to the present invention. The following description will be made with reference to FIG. 8B. Parts identical to those in FIGS. 8A are designated the same reference numerals, and will be omitted in the description.

Projector apparatus 20b of the second embodiment is a single-plate liquid crystal projector which displays images of a red component, a green component, and a blue component on single liquid crystal element 25 in time series, while sequentially turning on red light source device 21, green light source device 22, and blue light source device 23 synchronized with displayed images. Projector 20b also provides similar advantages to those of projector apparatus 20a in FIG. 8A.

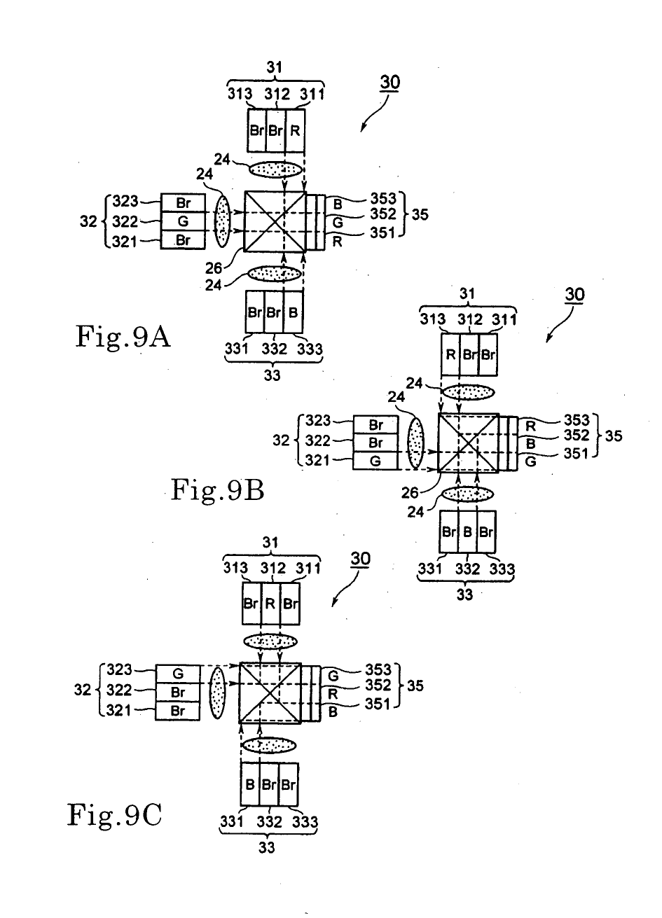

FIGS. 9A to 9C is a schematic diagram illustrating the configuration of a third embodiment of the projector apparatus according to the present invention. The following description will be made with reference to FIG. 9A to 9C. Parts identical to those in FIG. 8B are designated the same reference numerals, and will be omitted in the description. In FIGS. 9A to 9C, R represents red; G green; B blue; and Br black (unlit).

Projector apparatus 30 of the third embodiment comprises red light source device 31, green light source device 32, and blue light source device 33, like projector apparatus 20b in FIG. 8B. Red light source device 31 is divided into three areas 311-313 which can be lit independently of one another. Likewise, green light source device 32, blue light source device 33, and liquid crystal display element 35 are divided into three areas 321-323, 331-333, 351-353, respectively. Liquid crystal display element 35 displays images of a red component, a green component, and a blue component in each of areas 351-353 in time series in the order of FIG. 9A to FIG. 9C. In conformity to the displayed color, red light source device 31 switches the lit area 311-313 sequentially. Green light source device 32 and blue light source device 33 also operate in a similar manner. In this way, a color image can be displayed by sequentially irradiating each of areas 351-353 with red, green, and blue light in time series synchronized with the displayed color in each of areas 351-353 of liquid crystal display element 35. Projector apparatus 30 can suppress color breakup during the time-series display, in addition to providing similar advantages to those of projector apparatus 20b in FIG. 8B.

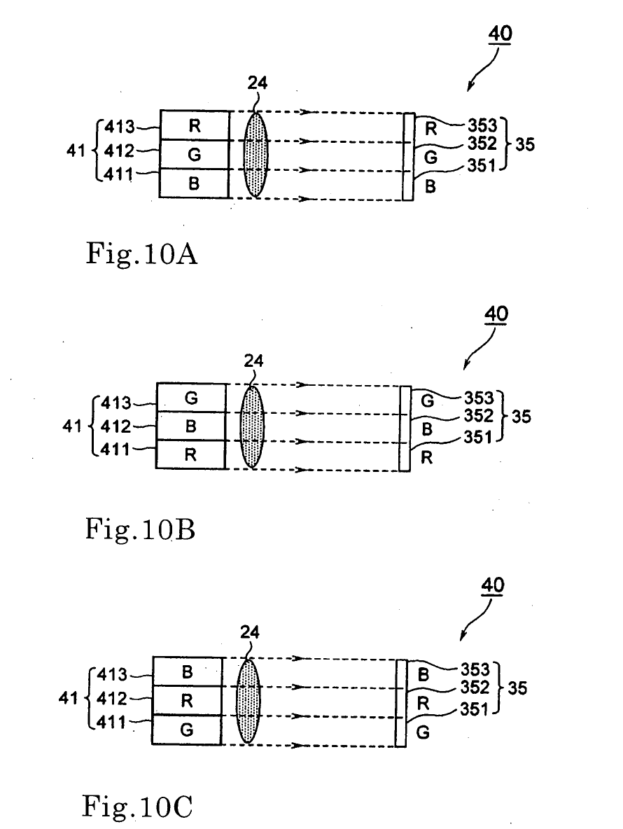

FIGS. 10A to 10C is a schematic diagram illustrating the configuration of a fourth embodiment of the projector apparatus according to the present invention. The following description will be made with reference to FIGS. 10A to 10C. Parts identical to those in FIGS. 9A to 9C are designated the same reference numerals, and will be omitted in the description.

Projector apparatus 40 of the fourth embodiment comprises three-color light source device 41. Three-color light source device 41 has a plurality of light source units 101 (FIG. 7), each of which emit three colors, i.e., red, green, and blue light arranged in matrix (for example, in three columns vertically and in three rows horizontally). Three-color light source device 41, illumination optical system 24, and liquid crystal display element 35 etc. can be combined into a single-plate projector. As illustrated in FIGS. 10A to 10C, projector apparatus 40 can display a color image by sequentially irradiating each of areas 351-353 with red, green, and blue color light using three-color light source device 41, synchronized with the displayed color in each of areas 351-353 of liquid crystal display element 35. Projector apparatus 40 can reduce a space required therefor, in addition to providing similar advantages to those of projector apparatus 30 illustrated in FIGS. 9A-9C.

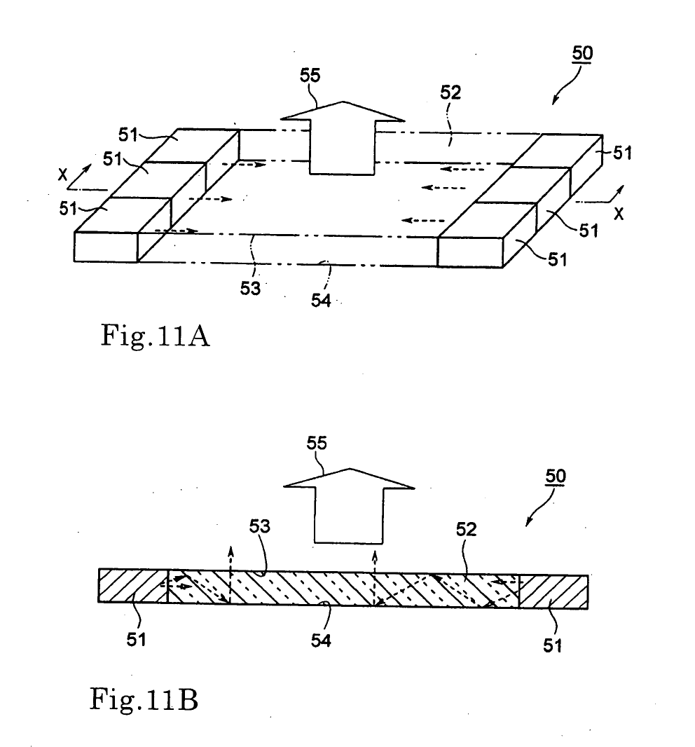

FIGS. 11A, 11B illustrate a first embodiment of an illuminator according to the present invention, wherein FIG. 11A is a perspective view, and FIG. 11B is a cross-sectional view taken along X-X line in FIG. 11A. The following description will be made with reference to FIGS. 11A, 11B.

Illuminator 50 of this embodiment has a plurality of white light source devices 51 and light guide plate 52. Emission planes of a plurality of white light source devices 51 face incident planes of light guide plate 52 to surround light guide plate 52. Each of white light source devices 51 may be, for example, light source device 10 (FIGS. 2A, 2B) which employs white LED for light emitting element 11 (FIGS. 2A, 2B). Light guide plate 52, which is made of an optically transparent member, has emission plane 53 and reflection plane 54 which oppose each other. Reflection plane 54 is machined to form a prism thereon or has a reflection pattern printed thereon. Light emitted from white light source devices 51 is provided as illumination light 55 through light guide plate 52. Illuminator 50 can be used for an illumination appliance for room illumination and the like, and for illumination of a display, Illuminator 50 can accomplish lower power consumption and higher luminance by use of light source device 10 (FIGS. 2A, 2B) which provides high light utilization efficiency for emitted light and a narrow light emission angle distribution. In other words, illuminator 50 can be provided with lower power consumption, low cost, and bright images. Alternatively, red, green, and blue LEDs may be used instead of white LEDs, or they may be replaced with LEDs each of which emits light in three colors, i.e., red, green, blue light.

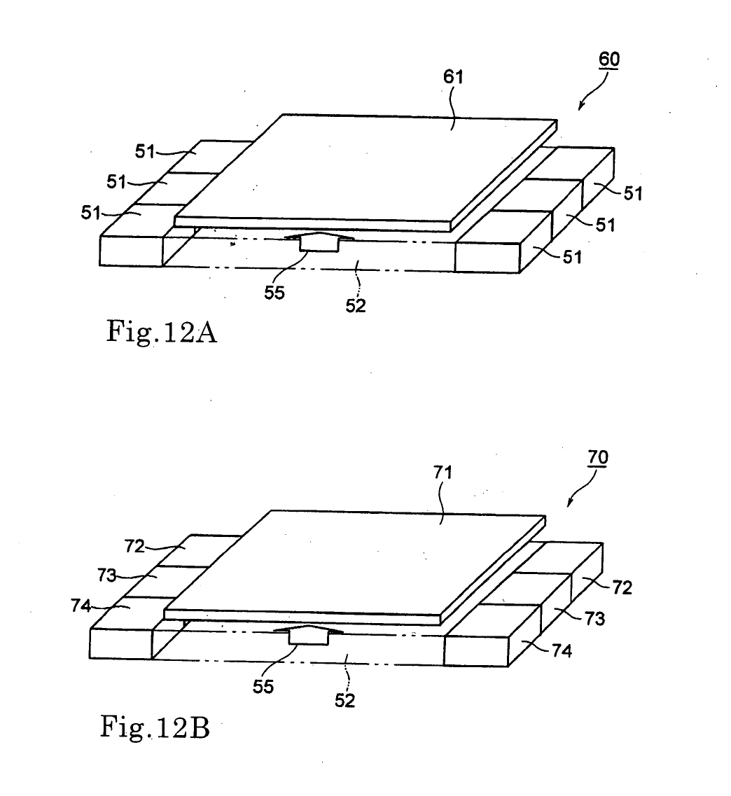

FIGS. 12A, 12B illustrate perspective views of liquid crystal displays according to the present invention, wherein FIG. 12A illustrates a first embodiment, and FIG. 12B illustrates a second embodiment. The following description will be made with reference to FIGS. 12A, 12B. Parts identical to those in FIGS. 11A, 11B are designated the same reference numerals, and will be omitted in the description.

Liquid crystal display 60 according to the first embodiment comprises liquid crystal display panel 61 having a color filter, disposed over the emission plane of illuminator 50 (FIGS. 11A, 11B). In other words, illuminator 50 is used as a back light.

Liquid crystal display 70 according to the second embodiment employs liquid crystal display panel 71 without color filter, instead of liquid crystal display panel 61, and employs red light source device 72, green light source device 73, and blue light source device 74 instead of white light source device 51. Liquid crystal display 70 displays images of a red component, a green component, and a blue component on liquid crystal display panel 71 in time series, while sequentially turning on red light source device 72, green light source device 73, and blue light source device 74 synchronized with these images.

Each of liquid crystal displays 60, 70 can accomplish lower power consumption and higher luminance by use of light source device 10 (FIGS. 2A, 2B) which provides high light utilization efficiency for emitted light and a narrow light emission angle distribution. In other words, resulting liquid crystal displays 60, 70 can each accomplish lower power consumption, low cost, and bright images.

Although certain preferred embodiments of the present invention have been shown and described in detail, it should be understood that various changes and modifications may be made without departing from the spirit or scope of the appended claims.

1. A light source device comprising:
a light source element including a light emitting element for emitting light mainly from a yz-plane in a three-dimensional orthogonal coordinate system defined by an x-axis, a y-axis, and a z-axis, and an element reflection plane for reflecting the light emitted from said light emitting element in the x-axis direction to head in a direction parallel with the yz-plane; and
a device reflection plane for reflecting the light emitted from said light source element in a direction parallel with the yz-plane to head in the y-axis direction.

2. The light source device according to claim 1, further comprising a lens disposed in the y-axis direction of said light source element.

3. The light source device according to claim 2, wherein said lens is a convex cylindrical lens.

4. The light source according to claim 1, wherein said device reflection plane has a concave shape in the yz-plane and in planes parallel with the yz-plane.

5. The light source device according to claim 4, wherein:
said device reflection plane has a concave shape in an xy-plane of the three-dimensional orthogonal coordinate system and in planes parallel with the xy-plane;
said device reflection plane has a pair of end surfaces in the z-axis direction formed to be plane parallel with the xy-plane; and
said device reflection plane has a pair of end surfaces in the x-axis direction formed to be plane parallel with the yz-plane.

6. The light source device according to claim 4, wherein said concave shape is a parabolic shape.

7. The light source device according to claim 1, wherein the emitted light from said light source element is at least one of red, green, and blue in color.

8. The light source device according to claim 1, wherein the emitted light from said light source element is white in color.

9. The light source device according to claim 1, wherein said light emitting element is a light emitting diode.

10. A combined light source device comprising a plurality of light source units, each comprising said light source device according to claim 1, said plurality of light source units being two-dimensionally arranged in alignment to the y-axis direction.

11. A combined light source device comprising a plurality of light source units, each comprising said light source device according to claim 2, said plurality of light source units being two-dimensionally arranged in alignment to the y-axis direction, and said lens being shared by said plurality of light source units.

12. The combined light source device according to claim 10, wherein any of said plurality of light source units emits light in the same color.

13. The combined light source device according to claim 10, wherein said plurality of light source units emit light in different colors from one another.

14. An projector apparatus comprising:
the light source devices according to claim 1 each for emitting red, green, and blue light;
display means for displaying an image for each of a red component, a green component, and a blue component; and
projection means for projecting the image on a screen by irradiating said display means with light in the same color as the image of the color component which is displayed on said display means, wherein the light is emitted from the associated light source device.

15. The projector apparatus according to claim 14, wherein:
said light source devices each sequentially emits the light in each of the colors, and
said display means sequentially displays the image for each of the color components in synchronization with said light source devices.

16. The projector apparatus according to claim 14, wherein:
said light source devices each emits light in a single color from an overall surface of said light source device, and
the color component displayed by said display means is in a single color over an overall surface of said display means.

17. The projector according to claim 14, wherein:
said light source device is divided into a plurality of areas for each of the colors, and
said display means is divided into a plurality of areas for each of the color components.

18. An illuminator comprising the light source device according to claim 1 for emitting red, green, and blue light.

19. An illuminator comprising the light source device according to claim 1 for emitting white light.

20. A liquid crystal display comprising:
a transmission type liquid crystal display panel; and
a back light disposed on a back of said liquid crystal display panel, said back light including the illuminator according to claim 18.

21. The liquid crystal display according to claim 20, wherein:
said illuminator sequentially emits red, green, and blue light, and
said liquid crystal display panel sequentially displays images of a red component, a green component, and a blue component in synchronization with lighting of said illuminator.

22. The liquid crystal display according to claim 21, wherein said illuminator illuminates an overall panel with a single color, and said liquid crystal display panel displays the image of a single color component over an overall panel.

23. The liquid crystal display according to claim 21, wherein:
said illuminator has an overall surface divided into a plurality of areas for each of the colors, and
said liquid crystal display panel has an overall panel surface divided into a plurality of areas for each of the color components.
